(19) United States
(12) Patent Application Publication
(10) Pub. No.: US 2021/0029690 A1
(43) Pub. Date: Jan. 28, 2021

(54) NETWORK CONTROL USING CROWD-SOURCED DATA

(71) Applicant: Microsoft Technology Licensing, LLC, Redmond, WA (US)

(72) Inventors: Amer Aref Hassan, Kirkland, WA (US); Hooman Shiranimehr, Sammamish, WA (US); Ronald F. Johnson, Kirkland, WA (US)

(21) Appl. No.: 16/517,938

(22) Filed: Jul. 22, 2019

(51) Int. Cl. H04W 72/04; H04W 64/00; H01Q 3/36; H04W 72/08

(52) U.S. Cl. CPC H04W 72/048; H04W 72/085; H01Q 3/36; H04W 64/006

(57) ABSTRACT

Techniques for configuring resources of wireless networks to improve service for users accessing the wireless networks are disclosed herein. In an example, one or more planned routes for computing devices are used to estimate a usage of a respective wireless network. The estimated usage is used to by a network manager to configure or reconfigure one or more resources of the wireless network.

### TECHNICAL FIELD

This document pertains generally, but not by way of limitation, to wireless networking, and particularly but not by way of limitation to configuring network resources based on crowd-sourced data.

### BACKGROUND

Several applications exist for users to plan travel routes in order to minimize a total travel time. While travelling along these planned routes, users often access one or more wireless networks for voice communication, or to access data, for example. These networks often connect to user devices or other computing devices through one or more wireless channels according to various wireless protocols. These wireless networks use various resources to facilitate communication with the devices over these wireless channels. If one or more resources of the wireless network are overloaded, malfunctioning, unavailable, or the like, service may be degraded for one or more users, which is undesirable because for some users, reliable network connectivity may be of utmost importance while travelling.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating an example system for crowd-sourcing network connectivity data.

FIG. 2 is a logical diagram illustrating a network map generated using crowd-sourced network data.

FIG. 3 is a flowchart illustrating a method of generating a network map using crowd-sourced data.

FIG. 4 is a diagram illustrating an example wireless network controlled by a network manager.

FIG. 5 is a diagram illustrating another wireless network controlled by a network manager.

FIG. 6 is a flowchart illustrating a method of reconfiguring network resources.

FIG. 7 is a block diagram illustrating an example of a machine upon which one or more embodiments may be implemented.

### DETAILED DESCRIPTION

A system and method are disclosed herein that utilize planned travel routes and crowd-sourced network maps indicative of one or more network parameters for various geographic locations to configure or control wireless network resources. Wireless networks can provide data and voice connection for computing devices traveling throughout geographical areas. While wireless networks may be able to monitor and measure values on the network-side, respective wireless networks may be less aware of the experience one or more computing devices have connecting to the respective wireless network, as well as the availability and quality of overlapping or adjacent networks. The crowd-sourced network map can provide a wireless network with information including connection quality and usage for the wireless network itself for various geographical locations, as well as connection quality and usage for other wireless networks in the same or similar geographical areas.

The respective wireless networks may also receive planned travel routes for computing devices planning to travel in the geographical areas for which the respective wireless network provides service. These planned travel routes can be used to determine anticipated loads on the wireless network from the computing devices planning to travel through the geographical area. Thus, the wireless network can utilize data from the network map and the planned routes to control wireless resources of the respective wireless network. For example, one or more dormant cells may be activated if there is predicted traffic for the respective cell, or if an adjacent overlapping cell is experiencing heavy traffic. In another example, one or more phased arrays may be activated for a geographic region expecting heavy traffic. The network may also transition users from one wireless technology to another wireless technology based on an anticipated load, or observed user experience.

By controlling network resources using the crowd-sourced network map and planned routes for one or more computing devices, a wireless network can better service its users. If the network map indicates that users are having a poor experience in a certain geographical area, the network resources can be controlled to improve that experience. This is beneficial in that it directly responds to the user's experience, rather than being based on network-side data.

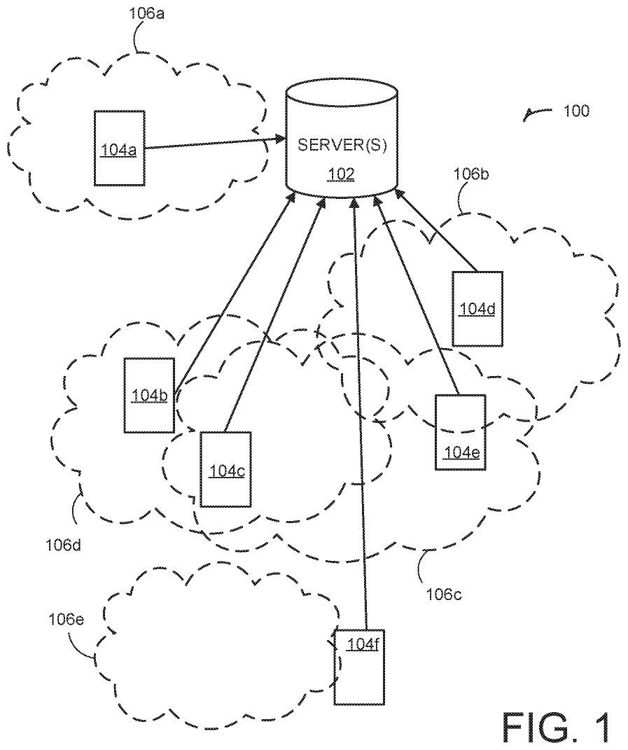

FIG. 1 is a diagram illustrating an example system 100 for crowd-sourcing network connectivity and quality data. The system 100 includes one or more servers 102 and user devices 104a-104f accessing one or more wireless networks 106a-106e. The user devices 104a-104f may be any user devices travelling along one or more geographical routes while accessing the one or more wireless networks 106a-106e. The wireless networks 106a-106e may be cellular networks, local area networks (LAN), wide area networks (WAN), or any other wireless networks. For example, the wireless networks 106a-106e may include one or more 3rd generation (3G), 4th generation (4G), long term evolution (LTE), 5th generation (5G) or any other cellular network, wireless networks according to the Institute of Electrical and Electronics Engineers (IEEE) 802.11 family of standards known as Wi-Fi®, IEEE 802.16 family of standards known as WiMax®, IEEE 802.16.4 family or any other wireless network. Each of the wireless networks 106a-106e may be configured to communicate with one or more of the user devices 104a-104f on one or more network channels. The channels may be frequency channels, for example, defined by the wireless standard for which the respective network communicates. While illustrated as five wireless networks 106a-106e and six user devices 104a-104e, any number of user devices may provide data regarding any. number of wireless networks.

The user devices 104a-104f may be configured to communicate with the servers 102 through any connection, including wired and wireless connections. Each user device 104a-104f, which may be a phone, tablet, laptop, wearable device or other personal computing device, may be configured to upload data to, and download data from, the servers 102. Each user device 104a-104f may upload to the servers 102 current location data along with data that includes one or more network parameters regarding one or more of the wireless networks 106a-106e, These network parameters can include, for example, network type, channel availability, channel quality, network availability, network download speeds, network upload speeds, voice availability, voice quality, and any other parameters or indicators for each respective network. The user devices 104a-104f may communicate the network parameters to the servers 102 through the respective networks 106a-106e for which the respective user device 104a-104f is reporting, or through another network. For example, a user device may report voice connection availability and/or quality to the servers 102 over a data connection. The data may be uploaded to the servers 102 in real time, or may be stored by a respective user device 104a-104f and uploaded to the servers 102 at a later time.

The servers 102 may include one or more applications configured to collect the network quality data from the user devices 104a-104f and compile a “crowd-sourced” network map for one or more geographical areas. For example, the network quality data may be provided to the servers 102 along with current geographical information, such as latitude and longitude coordinates. The network map may be a model of the wireless networks 106a-106e stored in a database with geographical coordinates mapped to specific networks 106a-106e and respective network quality data. The data can be grouped into geographical areas of any size based on the coordinates, such as city blocks, sections of a highway, or any other specified geographical area.

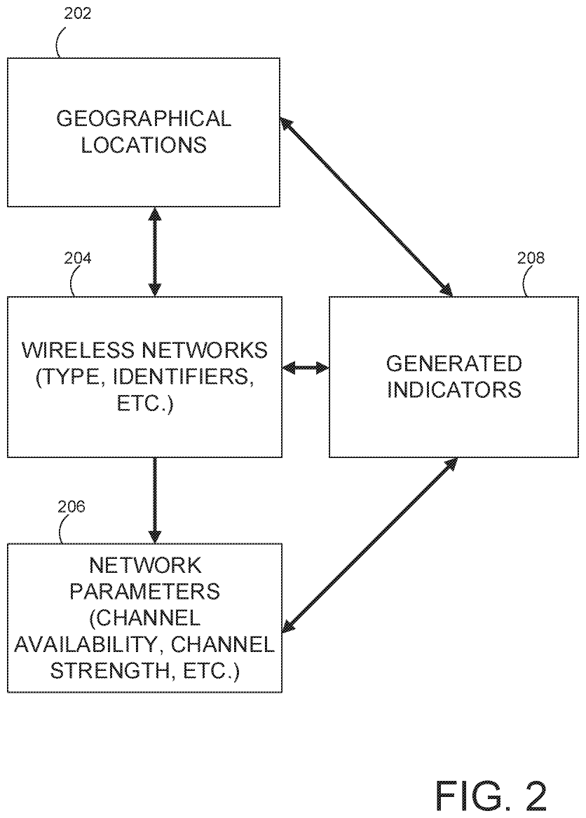

FIG. 2 is a logical diagram illustrating a network map 200 generated using crowd-sourced network quality data. The network map may store and map geographic locations 202, networks 204, and network parameters 206, for example, to one another. In other examples, further crowd-sourced data may be stored related to one or more wireless networks. The geographic locations 202 can include coordinates (such as latitude and longitude), and/or geographic areas such as city blocks, parcels of land, portions of highway, or any other geographically defined area.

The geographic locations 202 may map to one or more networks 204. For example, if a network is available for a specific geographic location, the respective network can be mapped to that geographic location (and/or that geographic location can be mapped to that network). The networks 204 may include data such as network identifiers, network type, and any other data specific to a wireless network. Each wireless network of the networks 204 can also map to one or more network parameters. The parameters can include network availability, channel availability, channel stability, channel strength, and any other parameters or indicators regarding respective wireless networks.

The information for the network map 200 may be stored in one or more databases in any desirable format. The network map 200 may be generated by the servers 102 or any other computing system using the crowd-sourced data received from the user devices 104a-104f. The network map may also generate and store indicators 208 generated by the servers 102 regarding the geographical locations 202, networks 204, and or parameters 206. In one example, the indicators 208 may include a list of all network outages for a respective wireless network 106a-106e for each geographical area. In another example, the indicators 208 may include a network quality indicator for each wireless network and/or channel for each geographical area. For example, for each channel of a network for each geographic area, the network map may include an indicator between 0 and 10, 0 for no connectivity and 10 for great connectivity. In another example, the indicators 208 may be a simple binary yes or no regarding whether or not a type of network is available for a respective geographical area. In some examples, the indicators may be generated using machine learning or any other algorithms.

The indicators 208 can also be generated to provide multiple indications for a respective network or channel. For example, each channel of a respective network can be assigned a score for each of various categories. In an example, the categories can include bandwidth, latency, throughput, jitter, error rate, and/or any other network performance categories. In an example, multiple user devices 104a-104e can provide data regarding a respective channel for a respective geographical area. The respective channel may then be scored using the data. These scores may then be used to inform connection choices for computing devices, for example. In an example, for users desiring to use Voice over Internet Protocol (VoIP) it may be desirable to know which channels have low latency, whereas for users streaming data, it may be desirable to know which channels have high bandwidth. Therefore, these indicators 208 may be used by one or more applications to plan network resources for computing devices traveling through the geographical locations 202.

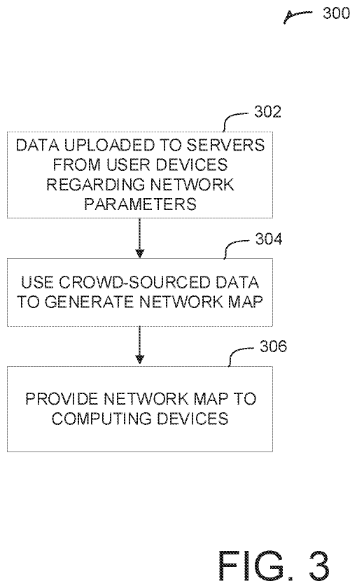

FIG. 3 is a flowchart illustrating a method 300 of generating a network map. The method 300 can be executed by the servers 102, a user device 104a-104f, or any other computer system. At step 302, user devices, such as phones, tablets, laptops, wearable devices, and other user devices, upload information regarding one or more parameters of a network for which a respective user device is connected. For example, a user device may be connected to a cellular network and using a cellular voice connection and/or a cellular data connection. In another example, the user device may be connected to a local area network or wide area network using any wireless protocol such as the IEEE 802.11 family of standards known as Wi-Fi®, IEEE 802.16 family of standards known as WiMax®, or any other network standard. In other examples, the device may be connected to another type of wireless network. In some examples, the user device may provide information regarding one or more parameters of networks and/or channels for which the respective user device is not connected. For example, service-set-identifiers (SSIDs) and signal strengths of nearby Wi-Fi® networks.

A respective user device may provide the device's geographical location, the cellular or other wireless network to which the device is wirelessly connected, the wireless channel through which the device is connected to the wireless network, a connection quality, and other parameters regarding the respective network. The device's location may be provided using geographic coordinates, such as latitude and longitude using the Global Positioning System (GPS), for example, an area descriptor, such as an intersection of two roads, or any other geographic data indicative of a device location. The connection quality may be a signal-to-noise ratio, an indication regarding successful connection, or any other indicator of connection quality. The user device may provide similar data regarding voice connection quality. In some examples, the device may provide a current navigational route the user device is travelling that was entered by the user.

At step 304, the collected data is used to generate a network map. The network map can take any form that allows mapping of network parameters for a wireless network to geographic locations. The network map data may be stored in one or more databases, for example, in any database storage format. Indicators may be generated using the uploaded user data, such as general network availability indicators for a geographical area. At step 306, a portion of, or the entire generated network map can be provided to other computing devices for use in planning network connections for a planned travel route, for example.

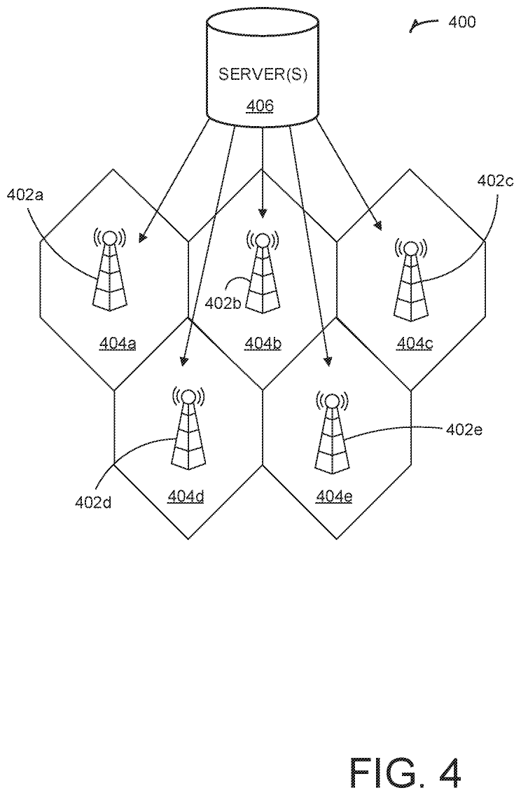

FIG. 4 is a diagram illustrating an example cellular network 400. The network 400, which may be any of the networks 106a-106e, includes base stations 402a-402e servicing respective cells 404a-404e. The base stations 402a-402e are connected to receive control from one or more servers 406. The base stations 402a-402e may include one or more transceiver components, such as radio-frequency (RF) antennas, for transmitting and receiving wireless signals via RF. In other examples, the base stations 402a-402e may include components configured to wirelessly communicate via optical or any other transmission type. The base stations 402a-402e may be base transceiver stations (BTS) for Global System for Mobile Communications (GSM) networks, Node Bs for Universal Mobile Telecommunications Systems (UMTS), eNodeBs for Long-Term Evolution (LTE) networks, SG base stations, or the like. The base stations 402a-402e may be configured to connect computing devices, such as the user devices 104a-104f, or any other computing devices, to the wider network. The transceiver components of the base stations 402a-402e may include one or more antenna components, including phased arrays for directed RF transmission and reception. The base stations 402a-402e may include several other wireless network resources such as local power sources, digital and analog circuitry, sensors, and the like.

The servers 406 may be configured to execute one or more applications to control the resources of the network 400. The servers 406 may be implemented as one or more computer systems, for example, executing the one or more applications configured to monitor and control resources of the network, including the base stations 402a-402e, components and/or resources of the base stations 402a-402e, or any other resources configurable or controllable by the servers 406. For example, the servers 406 may be configured to activate or deactivate one or more cells 402a-402e by controlling one or more components of the respective base stations 402a-402e, provision of one or more channels on the respective base stations 402a-402e, and the like To accomplish this, the servers 506 may send one or more data transmissions, messages, or other signals to the base stations 402a-402e causing the respective base stations 402a-402e to reconfigure the respective components and/or resources. While illustrated as standard cells, serving a large geographic area, the wireless network 400 may include one or more microcells, femtocells, picocells, or the like, configured to serve relatively small geographic areas.

The servers 406 may be configured to configure the resources of the network 400 based on one or more received travel routes for a computing device, the network map 200, and user data input, for example. In some examples, the resources may be controlled based only on the received travel routes, based only on the network map 200, based only on the user data input, or any combination thereof. The servers 406 may be configured to execute one or more applications that measure network parameters on the network side of the network 400. For example, the network 400 may monitor power usage of the base stations 402a-402e, received signal strength, bit error rates, and the like. The servers 406 may also be configured to receive the network map 200 (or in some examples generate the network map based on received data from users) indicative of parameters of the network 400 and other wireless networks accessed by user devices. Thus, the servers 406 can plan one or more resources based on how users are experiencing the network 400 and/or other overlapping or adjacent networks.

The servers 406 may also receive travel routes from user devices planning to travel through a geographical area served by the network 400. This way, the servers 406 may predict a number of anticipated users at a respective time and in a respective geographical area, and plan network resources accordingly. For example, the travel routes may indicate start locations, end locations, and routes between the start and end locations. The routes may be analyzed to determine if any portion of the respective route passes through a geographic area serviced by the network 400, for example. The number of routes passing through a particular area may be combined with historical data, for example, to predict a total usage for a respective time and area.

In addition to the planned travel routes, users may directly provide input regarding wireless needs to the servers 406 through one or more applications executing on respective user devices. The servers 406 may also predict wireless needs of computing devices, In some examples, the prediction may be based upon users' calendars. For example, if a calendar shows a VoIP call appointment, the system may infer that the respective user would like network resources that are optimal for VoIP calls. In other examples, the prediction may be based upon a machine-learned model that predicts the wireless needs of the user devices based upon one or more features. Example features may include the time of day, day of the week, day of the year, the planned route, a calendar of the user (e.g., showing a VoIP meeting), previous activity of the users, and the like.

By determining predicted (or known) wireless needs of user devices, the servers 406 can control wireless resources of the network 400 to provide a better service to the user devices. For example, one or more cells 404a-404e may be activated or deactivated. In one example, a cell may be activated that overlaps a respective cell to reduce the burden on the respective cell. In some other examples, a cell may serve a very small area, such as a microcell, and may only be activated when the servers 406 predict users will be within a range of the respective cell. Cells may also be deactivated based on the user routes, network map, and/or user input. For example, if the network map and user routes predict no users within a geographical area, a respective cell may be deactivated to conserve power, for example.

In another example, predicted usage or current usage based on the received routes and network map may be used to transfer user devices from one cellular technology to another cellular technology. For example, the base stations 402a-402e may include resources to communicate with computing devices on multiple cellular technologies including 3G, 4G, LIE, 5G, and the like. If the 5G resources are completely used, 5G users can be connected through 3G technology, for example, so as not to lose service. If a predicted usage for a geographical area indicates an increase in user devices that desire to connect through 5G, for example, some user devices currently connected using 5G may be offloaded to 4G to increase 5G capacity. This may be based on the computing device's wireless needs, for example. If some computing devices are accessing low amounts of data, they may be transferred to 3G, for example, to make room for computing devices that are predicted to access high amounts of data. In another example, one or more phased arrays of a respective base station 402a-402e may be activated based on a predicted increase in computing devices desiring to connect to 5G.

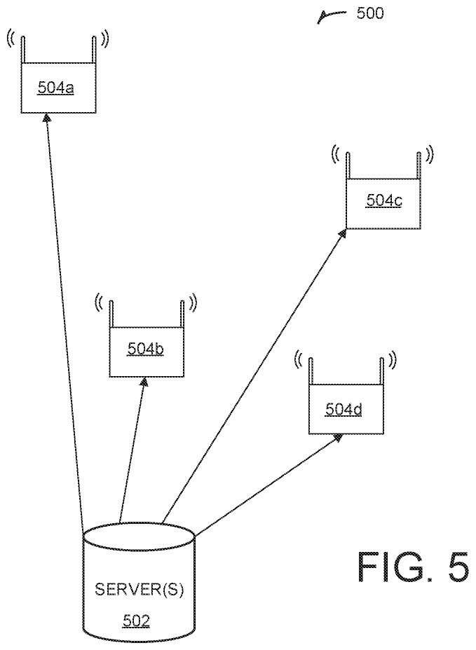

FIG. 5 is a diagram illustrating another example network 500, which may be any one of the networks 106a-106e. The network 500 includes servers 502 and access points 504a-504d. The servers 502 may be configured to execute one or more applications to control the resources of the network 500. The access points 504a-504d may be positioned to provide wireless connections to one or more user devices using Wi-Fig, WiMax®, or any other wireless protocol. The access points 504a-504d may be distributed throughout a city, for example, to implement a wide area network (WAN). While illustrated as all connected to the servers 502, the access points 504a-504d may be connected to one another to form a mesh network, for example. In some examples, further computing systems may be connected between any one or more of the access points 504a-504d and the servers 502 to perform further network management.

Similar to the servers 406, the servers 502 may be implemented as one or more computer systems, for example, executing one or more applications configured to monitor and control resources of the network 500, including the access points 504a-504d, components and/or resources of the access points 504a-504d, or any other resources controllable by the servers 502. For example, the servers 506 may be configured to activate or deactivate one or more access points 504a-504d, increase or decrease a power allocation of one or more of the access points 504a-504d, or configure any other resource of the network 500. To accomplish this, the servers 506 may send one or more data transmissions, messages, or other signals to the access points 504a-504d causing the respective access points 504a-504d to reconfigure the respective components and/or resources.

The servers 502 may be configured to control the resources of the network 500 based on one or more received travel routes and the network map 200, for example. In some examples, the resources may be controlled based only on the received travel routes, or based only on the network map 200. The servers 502 may be configured to execute one or more applications that measure network parameters on the network side of the network 500. For example, the servers 502 may monitor power usage, channel stability, current load, and the like. The servers 502 may also be configured to receive the network map 200 (or in some examples generate the network map 200 based on received user data) indicative of parameters of the network 500 and other wireless networks accessed by user devices (such as the network 400). Thus, the servers 502 can plan one or more resources based on how users are experiencing the network 500 and/or other overlapping or adjacent networks.

The servers 502 may also receive travel routes from user devices planning to travel through a geographical area served by the network 500. This way, the servers 502 may plan one or more resources of the network 500 based on a number of anticipated users at a respective time and in a respective geographical area similar to the servers 406 above. In addition to the planned travel routes, a user of a computing device may directly provide input to the servers 502 through one or more applications executing on the respective user devices regarding wireless needs of the computing devices. In other examples, predicted wireless needs may be determined by the servers 502 based on a prediction of the wireless needs of the computing devices. In some examples, the prediction may be based upon users' calendars. For example, if a calendar shows a VoIP call appointment, the system may infer that the respective user would like network resources that are optimal for VoIP calls. In other examples, the prediction may be based upon a machine-learned model that predicts the wireless needs of the user devices based upon one or more features. Example features may include the time of day, day of the week, day of the year, the planned route, a calendar of the user (e.g., showing a VoIP meeting), previous activity of the users, and the like.

By determining predicted wireless needs of user devices, the servers 502 can control wireless resources of the network 500 to provide a better service to the computing devices. For example, one or more access points 502a-502d may be activated or deactivated. In one example, one or more users may be offloaded from one access point 502a-502d to another access point 502a-502d based on current loads of the respective access points 502a-502d, and/or predicted usage of the respective access points 502a-502d. Access points 502a-502d may also be deactivated based on the user routes, network map, and/or user input. For example, if the network map and user routes predict no users within a geographical area, a respective access point 502a-502d may be deactivated to conserve power, for example.

In another example, the networks 400 and 500 may be operated by a same service provider. In this example, the servers 406 and 502 may work together to control resources of both respective networks 400 and 500. For example, the networks 400 and 500 may overlap in one or more geographical regions. For example, if predicted usage of a respective cell 404a-404e is high, and overlaps with the wireless network 500, user devices may be transferred to the network 500 (such as from a cellular 5G connection to a Wi-Fi® connection) to provide capacity for the increased load on the network 400. In other examples, computing devices may be transferred from the network 500 to the network 400 (such as from a Wi-Fi® connection to a cellular connection) to provide increased capacity for the network 500. While described with respect to various network resources, the networks 400 and 500 may control or configure any network resources based on any data from the network map, the received routes, and users of the respective computing devices planning to access the networks.

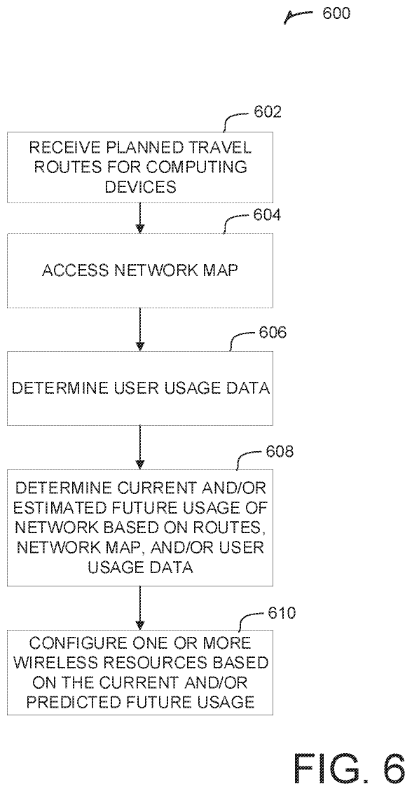

FIG. 6 is a flowchart illustrating a method of controlling network resources based on a network map, received travel routes, and/or other user data. At step 602, planned travel routes are received for one or more computing devices. These routes may have been generated by one or more applications running on the respective computing devices. In some examples, the respective computing devices may have generated the planned routes using the network map. The routes may have been generated based on minimizing an estimated time of arrival, for optimal network experience, or any other desires. A network manager (such as one or more servers of the network) may be configured to receive the planned routes from the computing devices. At step 604, the network map is received by the network manager. In some examples, the network manager may generate the network map based on received user data. In other examples, the network map may be received by the network manager from one or more remote servers. At step 606, the network manager receives other user data. This data may be in the form of direct user input from applications running on the computing devices. This data may also be predicted by the network manager based on known user data, such as calendars, historical use, or the like.

At step 608, the network manager determines a current usage and/or an estimated future usage of the respective network based on the received routes, the network map, and/or the user data. For example, a cellular network may predict upcoming loads for one or more respective cells of the network. The network manager may use the received routes to determine which computing devices are planning to travel through one or more areas serviced by the respective network. The network manager may also use indicators of the network map to predict usage. This usage can include a total number of computing devices accessing the network, how the computing devices are accessing the network (connection type, total data transfer, connection duration, etc.), and the like. For example, if the majority of computing devices are predicted to use VoIP, the resources may be configured to provide a greatest capacity for low latency connections. At step 610, the network configures one or more wireless resources based on the current and/or predicted network usage. This may include activating/deactivating cells, activating/deactivating access points, controlling a phased array, transferring users from one wireless technology to another (e.g., 5G to 4G), allocating additional backhaul to carry traffic to and from the access points and/or base stations, transferring users from one wireless network to another (e.g., cellular data network to a WiFi® WAN), combining channels (channel bonding or channel aggregation) in a 4G or 5G network, combining 4G or 5G with channels in an unlicensed spectrum, power control, or the like. In some examples, the network resources may be reconfigured based solely on the received routes, based only on the network map, based only on the user data, or any combination thereof.

The network resources may be reconfigured based upon one or more if-then rules that specifies, based upon a predicted amount of traffic and a current state of the network one or more reconfiguration actions. For example, if traffic is heavier than predicted, and if the base station has capacity to add a cell, then the cell should be brought into service just prior to the expected traffic. In other examples, machine-learning, models may be used, such as a logistic regression that may select a reconfiguration based upon the current state of the network, the traffic map, and the like. The models may be previously trained based upon historical network states, historical traffic maps, and labels which specify a desired reconfiguration.

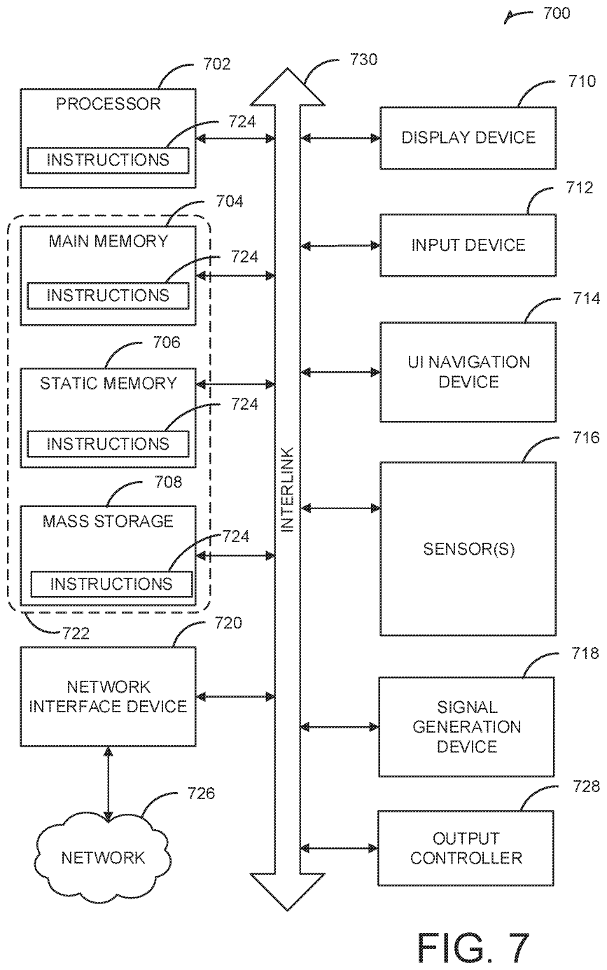

FIG. 7 illustrates a block diagram of an example machine 700 upon which any one or more of the techniques (e.g., methodologies) discussed herein may perform. For example, the machine 700 can be any one or more of the servers 102, 406, and/or 502, and/or user devices 104a-104f. Examples, as described herein, may include, or may operate by, logic or a number of components, or mechanisms in the machine 700. Circuitry (e.g., processing circuitry) is a collection of circuits implemented in tangible entities of the machine 700 that include hardware (e.g., simple circuits, gates, logic, etc.). Circuitry membership may be flexible over time. Circuitries include members that may, alone or in combination, perform specified operations when operating. in an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 700 follow.

In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 700 may include a hardware processor 702 (e.g., a central processing unit (CPU), a graphics processing unit (GPU), a hardware processor core, or any combination thereof), a main memory 704, a static memory (e.g., memory or storage for firmware, microcode, a basic-input-output (BIOS), unified extensible firmware interface (UEFI), etc.) 706, and mass storage 708 (e.g., hard drive, tape drive, flash storage, or other block devices) some or all of which may communicate with each other via an interlink (e.g., bus) 730. The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 708, a signal generation device 718 (e.g., a speaker), a network interface device 720, and one or more sensors 716, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 702, the main memory 704, the static memory 706, or the mass storage 708 may be, or include, a machine readable medium 722 on which is stored one or more sets of data structures or instructions 724 (e.g., software) embodying or utilized by any one or more of the techniques or functions described herein. The instructions 724 may also reside, completely or at least partially, within any of registers of the processor 702, the main memory 704, the static memory 706, or the mass storage 708 during execution thereof by the machine 700. In an example, one or any combination of the hardware processor 702, the main memory 704, the static memory 706, or the mass storage 708 may constitute the machine readable media 722. While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” play include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions, Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may be further transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.16.4 family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible medium to facilitate communication of such software. A transmission medium is a machine readable medium.

The above description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method of planning network service for devices traveling along a specified routes, the method comprising:
using one or more hardware processors:
receiving one or more planned routes for one or more computing devices planning to physically travel within a geographical area;
estimating a usage of a respective wireless network using the one or more planned routes;
and
causing a reconfiguration of one or more wireless resources of the respective wireless network based on the estimated usage of the respective wireless network.

2. The method of claim 1, wherein causing the reconfiguration of the one or more wireless resources of the respective wireless network comprises activating a dormant cell for the respective network based on the estimated usage.

3. The method of claim 1, wherein causing the reconfiguration of the one or more wireless resources of the respective wireless network comprises reconfiguring a phased array for the respective network based on the estimated usage.

4. The method of claim 1, wherein causing the reconfiguration of the one or more wireless resources of the respective wireless network comprises reconfiguring one or more connection parameters for connections between the respective wireless network and one or more user devices based on the estimated usage.

5. The method of claim 1, further comprising:
receiving network quality data for one or more wireless networks from one or more user devices traveling within the geographical area; and
generating a quality map based on the network quality data from the one or more user devices;
wherein causing the reconfiguration of the one or more wireless resources of the respective wireless network is based further on the quality map.

6. The method of claim 5, wherein the respective wireless network is a first wireless network, and wherein reconfiguring the one or more wireless resources comprises reconfiguring the one or more wireless resources based on the one or more network parameters of a second wireless network indicated by the quality map.

7. The method of claim 1, further comprising:
requesting a quality map from at least one server location, the quality map generated based on network quality data received from one or more user devices, the network quality data measured by the one or more user devices; and
receiving, from the at least one server location, at least a portion of the quality map that corresponds to the planned route;
wherein causing the reconfiguration of the one or more wireless resources of the respective wireless network is based further on the quality map.

8. A system for planning network service for devices traveling along a specified routes, the system comprising:
one or more hardware processors;
a memory, storing instructions, which when executed, cause the one or more hardware processors to perform operations comprising:
receiving one or more planned routes for one or more computing devices planning to physically travel within a geographical area;
estimating a usage of a respective wireless network using the one or more planned routes;
and
causing a reconfiguration of one or more wireless resources of the respective wireless network based on the estimated usage of the respective wireless network.

9. The system of claim 8, wherein the operations of causing the reconfiguration of the one or more wireless resources of the respective wireless network comprise activating a dormant cell for the respective network based on the estimated usage.

10. The system of claim 8, wherein the operations of causing the reconfiguration of the one or more wireless resources of the respective wireless network comprise reconfiguring a phased array for the respective network based on the estimated usage.

11. The system of claim 8, wherein the operations of causing the reconfiguration of the one or more wireless resources of the respective wireless network comprise reconfiguring one or more connection parameters for connections between the respective wireless network and one or more user devices based on the estimated usage.

12. The system of claim 8, further comprising operations of:
receiving network quality data for one or more wireless networks from one or more user devices traveling within the geographical area; and
generating a quality map based on the network quality data from the one or more user devices;
wherein the operations of causing the reconfiguration of the one or more wireless resources of the respective wireless network is based further on the quality map.

13. The system of claim 12, wherein the respective wireless network is a first wireless network, and wherein the operations of reconfiguring the one or more wireless resources comprises reconfiguring the one or more wireless resources based on the one or more network parameters of a second wireless network indicated by the quality map.

14. The system of claim 8, further comprising operations of:
requesting a quality map from at least one server location, the quality map generated based on network quality data received from one or more user devices, the network quality data measured by the one or more user devices; and
receiving, from the at least one server location, at least a portion of the quality map that corresponds to the planned route;
wherein the operations of causing the reconfiguration of the one or more wireless resources of the respective wireless network is based further on the quality map.

15. A system for planning network service for devices traveling along a specified routes, the system comprising:
means for receiving one or more planned routes for one or more computing devices planning to physically travel within a geographical area;
means for estimating a usage of a respective wireless network using the one or more planned routes;
and
means for causing a reconfiguration of one or more wireless resources of the respective wireless network based on the estimated usage of the respective wireless network.

16. The system of claim 15, wherein the means for causing the reconfiguration of the one or more wireless resources of the respective wireless network comprise means for activating a dormant cell for the respective network based on the estimated usage.

17. The system of claim 15, wherein the means for causing the reconfiguration of the one or more wireless resources of the respective wireless network comprise means for reconfiguring a phased array for the respective network based on the estimated usage.

18. The system of claim 15, wherein the means for causing the reconfiguration of the one or more wireless resources of the respective wireless network comprise means for reconfiguring one or more connection parameters for connections between the respective wireless network and one or more user devices based on the estimated usage.

19. The system of claim 15, further comprising:
means for receiving network quality data for one or more wireless networks from one or more user devices traveling within the geographical area; and
means for generating a quality map based on the network quality data from the one or more user devices;
wherein the means for causing the reconfiguration of the one or more wireless resources of the respective wireless network is based further on the quality map.

20. The system of claim 15, further comprising:
means for requesting a quality map from at least one server location, the quality map generated based on network quality data received from one or more user devices, the network quality data measured by the one or more user devices; and
means for receiving, from the at least one server location, at least a portion of the quality map that corresponds to the planned route;
wherein the means for causing the reconfiguration of the one or more wireless resources of the respective wireless network is based further on the quality map.
